(19) United States
(12) Patent Application Publication
(10) Pub. No.: US 2025/0103719 A1
(43) Pub. Date: Mar. 27, 2025

(54) SECURE HANDSHAKE FOR HOST TO NON-HOST EXECUTION

(71) Applicant: Dell Products L.P., Round Rock, TX (US)

(72) Inventors: Shekar Babu SURYANARAYANA, Bangalore (IN); Sagar ALATGI, Pune (IN); Aniket SUREKAR, Nanded (IN)

(73) Assignee: Dell Products L.P., Round Rock, TX (US)

(21) Appl. No.: 18/473,097

(22) Filed: Sep. 22, 2023

(51) Int. Cl. G06F 21/57; H04L 9/32

(52) U.S. Cl. CPC G06F 21/575; G06F 21/572; H04L 9/3234; G06F 2221/034

(57) ABSTRACT

An information handling system may include a host central processing unit (CPU), a non-CPU processing unit, and a non-host device. The information handling system may be configured to, during execution of a pre-boot environment: establish trust between the host CPU and the non-host device via a cryptographic measurement; transfer data regarding the established trust from the host CPU to the non-CPU processing unit; and execute code associated with the non-host device on the non-CPU processing unit.

### TECHNICAL FIELD

The present disclosure relates in general to information handling systems, and more particularly to allowing secure communication between host and non-host devices.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Portions of this disclosure may be used in conjunction with techniques described in U.S. patent application Ser. No. 18/472,868, entitled “SMART SURVEILLANCE SERVICE IN PRE-BOOT FOR QUICK REMEDIATIONS,” is which being filed concurrently herewith and is incorporated by reference herein in its entirety.

As one of ordinary skill in the art with the benefit of this disclosure will appreciate, many systems use a Trusted Platform Module (TPM) to establish a secure operating environment. A TPM may be used to perform code measurements and store results in platform configuration registers (PCRs) so that deviations between one boot and the next may be detected. TPM measurements typically occur during execution of a pre-boot environment such as a Unified Extensible Firmware Interface (UEFI) Basic Input/Output System (BIOS).

This disclosure described solutions applicable to situations in which trust needs to be established between a host device (e.g., a CPU of an ordinary computing system) and a non-host device (e.g., a wireless networking adapter such as a Wi-Fi or Bluetooth adapter) coupled to the host device.

The Security Protocol and Data Model (SPDM) Specification defines messages, data objects, and sequences for performing message exchanges between devices over a variety of transport and physical media. The description of message exchange includes authentication of hardware identities and measurement for firmware identities. SPDM enables efficient access to low-level security capabilities and operations.

However, there is currently no secure mechanism to handle non-host devices assigned by the host using a multiprocessing (MP) protocol. Further, there is no existing system to verify the identity and reliability of non-host devices via certificates and digital signatures assigned by the parent host to the child non-host. Once assigned to the child non-host, there is no mechanism to prevent tampering during the execution of operations.

In modern systems, during the boot process, TPM code may run on the host CPU, and if code associated with a non-host device is running on a non-CPU processing unit such as an application processing unit (APU) or graphics processing unit (GPU), currently there is no way to perform secure code measurements prior to execution. In multi-processing environments, systems are also vulnerable to time-of-creation/time-of-use (ToC/ToU) attacks, as will be understood by one of ordinary skill in the art with the benefit of this disclosure.

Embodiments thus provide improvements in establishing trust between a host system and a non-host system.

It is to be noted that various terms discussed herein are described in the UEFI Specification Version 2.10, released August 2022 (hereinafter, UEFI Specification), which is hereby incorporated by reference in its entirety. One of ordinary skill in the art with the benefit of this disclosure will understand its applicability to other specifications (e.g., prior or successor versions of the UEFI Specification). Further, some embodiments may be applicable to different technologies other than UEFI.

It is also to be noted that various terms discussed herein are described in the SPDM Specification Version 1.2.0, released Dec. 14, 2021 (hereinafter, SPDM Specification), which is hereby incorporated by reference in its entirety. One of ordinary skill in the art with the benefit of this disclosure will understand its applicability to other specifications (e.g., prior or successor versions of the SPDM Specification). Further, some embodiments may be applicable to different technologies other than SPDM.

It is also to be noted that various terms discussed herein are described in the Trusted Platform Module (TPM) Library Specification, Family “2.0”, Level 00, Revision 01.59, released November 2019 (hereinafter, TPM Specification), which is hereby incorporated by reference in its entirety. One of ordinary skill in the art with the benefit of this disclosure will understand its applicability to other specifications (e.g., prior or successor versions of the TPM Specification). Further, some embodiments may be applicable to different technologies other than TPM.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with establishing trust between a host system and a non-host system may be reduced or eliminated.

In accordance with embodiments of the present disclosure, an information handling system may include a host central processing unit (CPU), a non-CPU processing unit, and a non-host device. The information handling system may be configured to, during execution of a pre-boot environment: establish trust between the host CPU and the non-host device via a cryptographic measurement; transfer data regarding the established trust from the host CPU to the non-CPU processing unit; and execute code associated with the non-host device on the non-CPU processing unit.

In accordance with these and other embodiments of the present disclosure, a method may include an information handling system establishing trust during a pre-boot environment between a host central processing unit (CPU) of the information handling system and a non-host device of the information handling system via a cryptographic measurement; the information handling system transferring data regarding the established trust from the host CPU to a non-CPU processing unit of the information handling system; and the information handling system executing code associated with the non-host device on the non-CPU processing unit.

In accordance with these and other embodiments of the present disclosure, an article of manufacture may include a non-transitory, computer-readable medium having computer-executable code thereon that is executable by an information handling system for: establishing trust during a pre-boot environment between a host central processing unit (CPU) of the information handling system and a non-host device of the information handling system via a cryptographic measurement; transferring data regarding the established trust from the host CPU to a non-CPU processing unit of the information handling system; and executing code associated with the non-host device on the non-CPU processing unit.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the 5 accompanying drawings, in which like reference numbers indicate like features, and wherein:

FIG. 1 illustrates a block diagram of an example information handling system, in accordance with embodiments of the present disclosure; and

FIGS. 2-3 illustrate sequence diagrams, in accordance with embodiments of the present disclosure.

### DETAILED DESCRIPTION

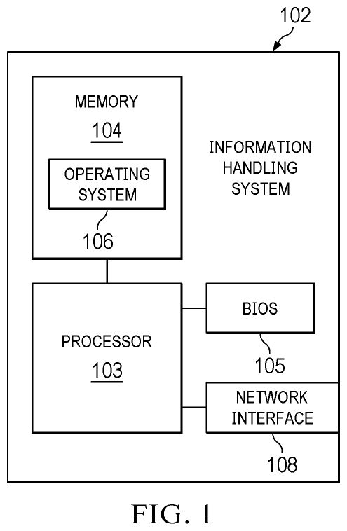

Preferred embodiments and their advantages are best understood by reference to FIGS. 1 through 3, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

As discussed above, embodiments of this disclosure provide a method to securely establish a handshake between host and non-host devices, a method to authenticate and save measurements of non-host devices, and a method to ensure resistance to ToC/TOU attacks.

In one embodiment, a pre-boot environment may be configured to initialize a CPU and an APU to take specified workloads (e.g., boot monitoring services) to decrease boot time and enhance reliability. In current implementations, the boot path is tightly coupled to a single CPU core. However, embodiments may decouple the boot code to run in parallel (e.g., on multiple CPU cores as well as on APU and/or GPU cores) and initialize the Bluetooth and/or Wi-Fi stack early in the PEI boot phase, allowing for live telemetry from the pre-boot environment.

Secure host to non-host measurements provide zero-trust execution while parallel processing in the early pre-boot environment reduces vulnerabilities. A trust extension measurement protocol as described herein also ensures resistance to ToC/TOU attacks.

In one embodiment, a Secure Loading Mechanism may operate as follows. The BIOS running on the primary CPU may perform what is called “non-host” measurements for a device such as a Wi-Fi/Bluetooth adapter device. This can be accomplished by utilizing the SPDM protocol, facilitating the measurement and verification of code and data associated with non-host devices once they are discovered. These measurements can be recorded in the corresponding PCRs, including PCR2 and PCR3 of the TPM depending on the specific components and configurations being measured. This process ensures that the integrity and authenticity of the non-host device's code and data can be verified and trusted before loading it for execution on an APU core.

PCR measurement verification may be carried out as follows in one embodiment. Depending on the architecture, generally, the BIOS may gather measurements from each of the devices as they are being discovered. During the boot process, the measurements stored in the TPM PCRs are verified to confirm the consistency of the boot process from one boot to the next. This can be done by comparing the PCR values with expected values or by using a trusted reference to ensure that the measurements match the expected configuration.

To provide a ToC/TOU resistant solution in one embodiment, the following protocol may be used.

1. The SPDM measurements may be gathered asynchronously or periodically after boot by a verifier application using the same SPDM protocol. If the pre-boot measurements gathered by the BIOS in the TPM event log (PCR2) do not match the second set of measurements gathered later by the verifier, then the verifier can determine if something in the non-host device has drifted or been changed.

2. Devices should have their own roots of trust, such that the measurements provided by these devices via SPDM (referred to as SPDM responders) are created by the device's own internal root of trust, which guarantees the code measured is the same code that booted. One implementation for this type of self-measuring device is the Trusted Computing Group (TCG) Device Identifier Composition Engine (DICE).

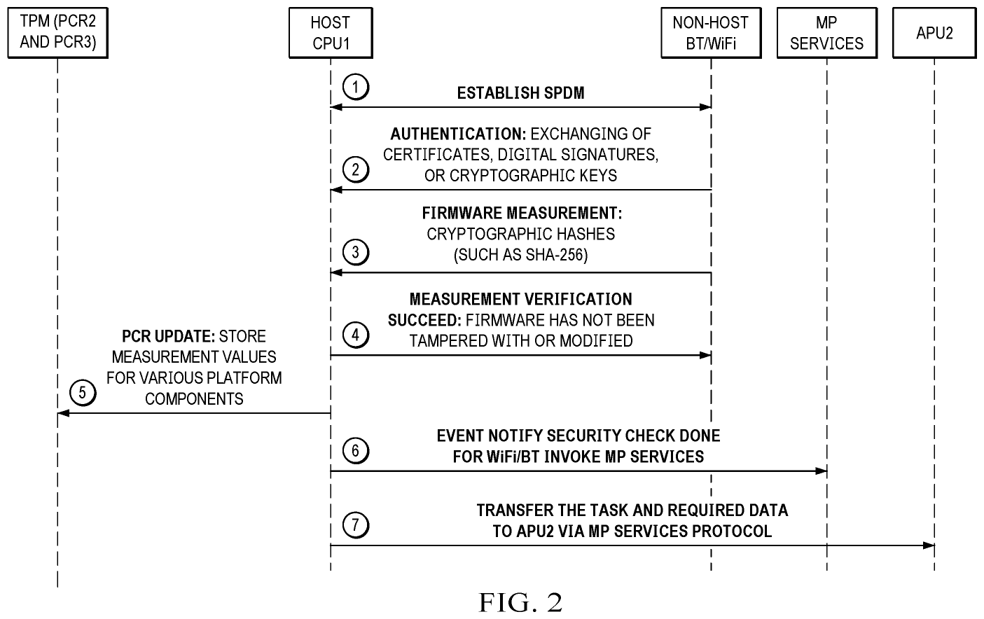

FIG. 2 provides an example sequence diagram for secure loading mechanisms of non-host devices. The security and trust measurement steps shown in FIG. 2 may be used to perform SPDM protocol verification for the non-host device, store the data into PCRs, use the MP service protocol to load non-host code execution on APU2, and validate continuous PCR data while running on APU2 to prevent tampering with the firmware and ensure a secure and trusted system environment.

This method performs protocol verification and PCR storing. At step 1, a SPDM session may be established between CPU1 (the host CPU or CPU core) and the non-host device. The non-host device may be authenticated at step 2 to ensure its identity and trustworthiness using certificates, digital signatures, and/or cryptographic keys.

At step 3, measurements may be obtained of the non-host device's firmware components, typically in the form of cryptographic hashes. At step 4, the integrity of the non-host device's firmware may be verified by comparing the received measurements with expected values.

At step 5, the corresponding PCR value within the TPM may be updated with the measurement data to store it securely.

At step 6, the MP services protocol may be used to securely load non-host code on APU2 for execution. At step 7, the code may be transferred to the APU2 device, ensuring its integrity and authenticity through cryptographic means such as digital signatures or message authentication codes (MACs). The code integrity may be validated on the APU2 device before executing it, comparing its measurements or hashes against the expected values.

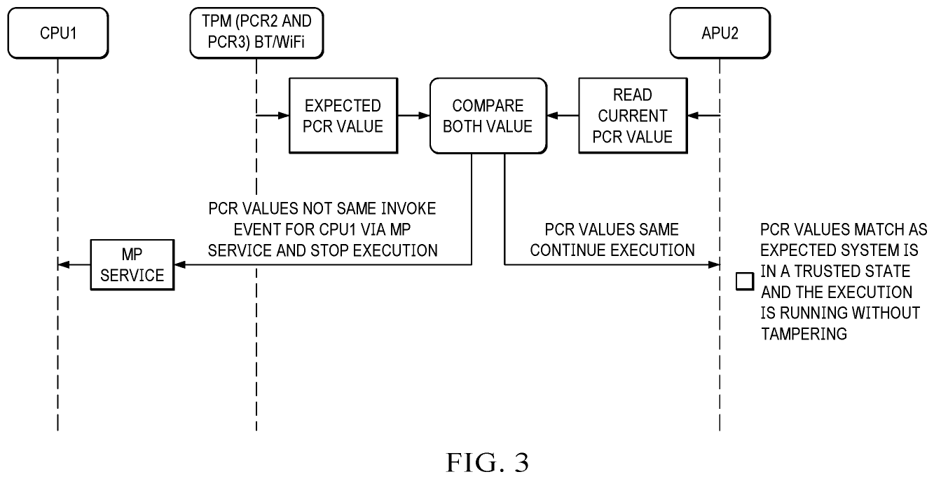

FIG. 3 provides an example sequence diagram for asynchronous/periodic checking of the SPDM measurements after the code has begun executing on APU2.

For example, at periodic intervals, the method shown in FIG. 3 may be carried out to ensure that the code has not been altered. The PCR values may be continuously (or repeatedly) monitored and validated while the non-host code is running on the APU2 device.

The current PCR values may be compared with the expected values to detect any unauthorized modifications or tampering attempts. If the PCR values deviate from the expected values, appropriate security measures such as terminating the execution or triggering an alert may be taken. This ensures the continuity and integrity of the PCR values during the execution on the APU2 device.

One of ordinary skill in the art with the benefit of this disclosure will understand that the preferred initialization point for the method depicted in FIGS. 2-3 and the order of the steps comprising the methods may depend on the implementation chosen. In these and other embodiments, the methods may be implemented as hardware, firmware, software, applications, functions, libraries, or other instructions. Further, although FIGS. 2-3 disclose a particular number of steps to be taken with respect to the disclosed methods, the methods may be executed with greater or fewer steps than depicted. The methods may be implemented using any of the various components disclosed herein (such as the components of FIG. 1), and/or any other system operable to implement the methods.

Although various possible advantages with respect to embodiments of this disclosure have been described, one of ordinary skill in the art with the benefit of this disclosure will understand that in any particular embodiment, not all of such advantages may be applicable. In any particular embodiment, some, all, or even none of the listed advantages may apply.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Unless otherwise specifically noted, articles depicted in the drawings are not necessarily drawn to scale. However, in some embodiments, articles depicted in the drawings may be to scale.

Further, reciting in the appended claims that a structure is “configured to” or “operable to” perform one or more tasks is expressly intended not to invoke 35 U.S.C. § 112 (f) for that claim element. Accordingly, none of the claims in this application as filed are intended to be interpreted as having means-plus-function elements. Should Applicant wish to invoke § 112 (f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
a host central processing unit (CPU);
a non-CPU processing unit; and
a non-host device;
wherein the information handling system is configured to, during execution of a pre-boot environment:
establish trust between the host CPU and the non-host device via a cryptographic measurement;
transfer data regarding the established trust from the host CPU to the non-CPU processing unit; and
execute code associated with the non-host device on the non-CPU processing unit.

2. The information handling system of claim 1, wherein the non-host device comprises a Bluetooth and/or Wi-Fi adapter.

3. The information handling system of claim 1, wherein the pre-boot environment is a Unified Extensible Firmware Interface (UEFI) Basic Input/Output System (BIOS).

4. The information handling system of claim 1, wherein the cryptographic measurement is a Trusted Platform Module (TPM) measurement stored in one or more platform configuration registers (PCRs).

5. The information handling system of claim 1, wherein, subsequent to transferring the data to the non-CPU processing unit, the information handling system is configured to repeatedly confirm that the code executing on the non-CPU processing unit has not been altered.

6. The information handling system of claim 1, wherein the non-CPU processing unit comprises at least one of an application processing unit (APU) and a graphics processing unit (GPU).

7. A method comprising:
an information handling system establishing trust during a pre-boot environment between a host central processing unit (CPU) of the information handling system and a non-host device of the information handling system via a cryptographic measurement;
the information handling system transferring data regarding the established trust from the host CPU to a non-CPU processing unit of the information handling system; and
the information handling system executing code associated with the non-host device on the non-CPU processing unit.

8. The method of claim 7, wherein the non-host device comprises a Bluetooth and/or Wi-Fi adapter.

9. The method of claim 7, wherein the pre-boot environment is a Unified Extensible Firmware Interface (UEFI) Basic Input/Output System (BIOS).

10. The method of claim 7, wherein the cryptographic measurement is a Trusted Platform Module (TPM) measurement stored in one or more platform configuration registers (PCRs).

11. The method of claim 7, wherein, subsequent to transferring the data to the non-CPU processing unit, the information handling system is configured to repeatedly confirm that the code executing on the non-CPU processing unit has not been altered.

12. The method of claim 7, wherein the non-CPU processing unit comprises at least one of an application processing unit (APU) and a graphics processing unit (GPU).

13. An article of manufacture comprising a non-transitory, computer-readable medium having computer-executable code thereon that is executable by an information handling system for:
establishing trust during a pre-boot environment between a host central processing unit (CPU) of the information handling system and a non-host device of the information handling system via a cryptographic measurement;
transferring data regarding the established trust from the host CPU to a non-CPU processing unit of the information handling system; and
executing code associated with the non-host device on the non-CPU processing unit.

14. The article of claim 13, wherein the non-host device comprises a Bluetooth and/or Wi-Fi adapter.

15. The article of claim 13, wherein the pre-boot environment is a Unified Extensible Firmware Interface (UEFI) Basic Input/Output System (BIOS).

16. The article of claim 13, wherein the cryptographic measurement is a Trusted Platform Module (TPM) measurement stored in one or more platform configuration registers (PCRs).

17. The article of claim 13, wherein, subsequent to transferring the data to the non-CPU processing unit, the information handling system is configured to repeatedly confirm that the code executing on the non-CPU processing unit has not been altered.

18. The article of claim 13, wherein the non-CPU processing unit comprises at least one of an application processing unit (APU) and a graphics processing unit (GPU).
